(19) United States
(12) Patent Application Publication
(10) Pub. No.: US 2006/0191398 A1
(43) Pub. Date: Aug. 31, 2006

(54) Universal 12 note musical ear training and interval study method and system

(76) Inventor: Mark John Sternal, Crystal River, FL (US)

Correspondence Address: Mark John Sternal, 452 SE Paradise Point Rd, Crystal River, FL, 34429, US

(21) Appl. No.: 11/065,550

(22) Filed: Feb. 25, 2005

(51) Int. Cl. G09B 15/02

(52) U.S. Cl. 84/483.2

(57) ABSTRACT

System and method for quickly learning 12 universal musical patterns that encompass all notes, melodies, harmonies, chords, and composition of western music without the use of traditional musical notation, or extensive training in music theory. Study and application of said method will result in increased recognition of distinct sound qualities of each pattern regardless of which musical note said pattern has been applied to. The system or method is provided in a verbal or written explanation, which can be supplemented by visual or graphical display of a chosen instrument.

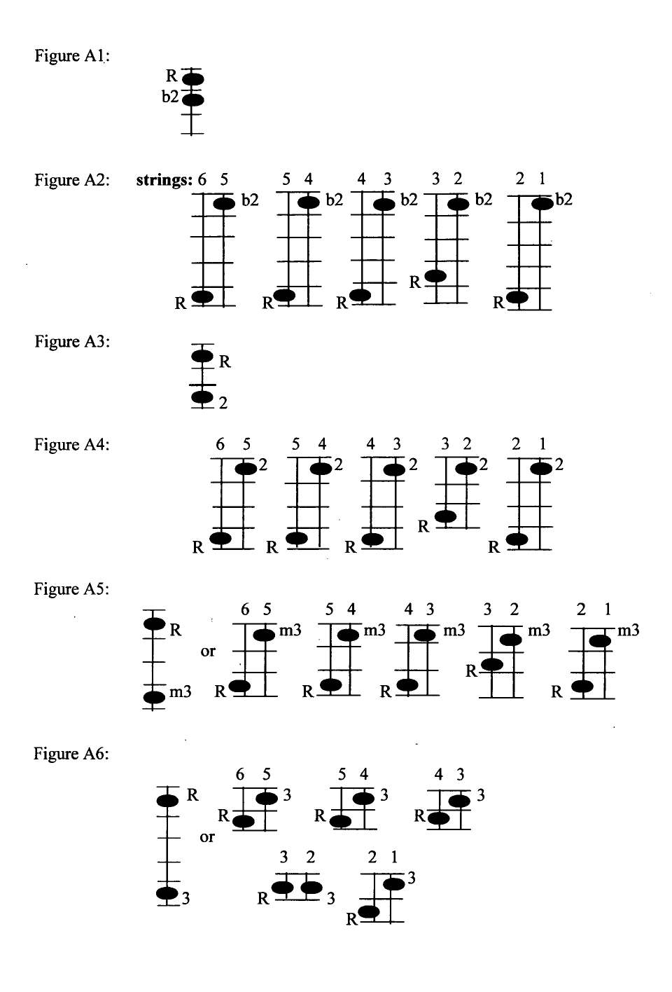

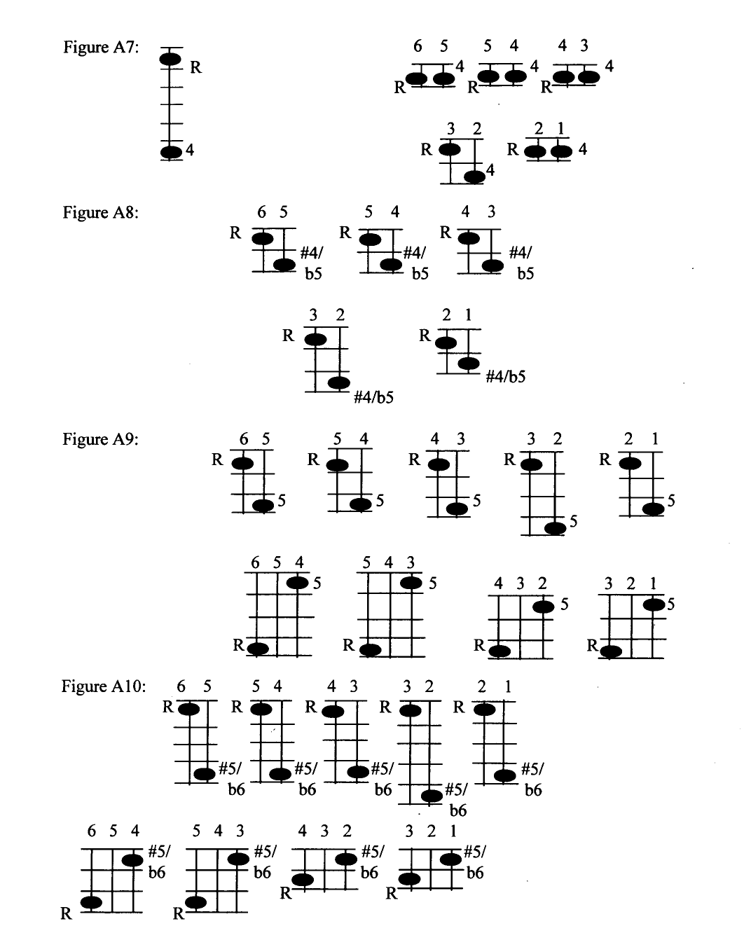

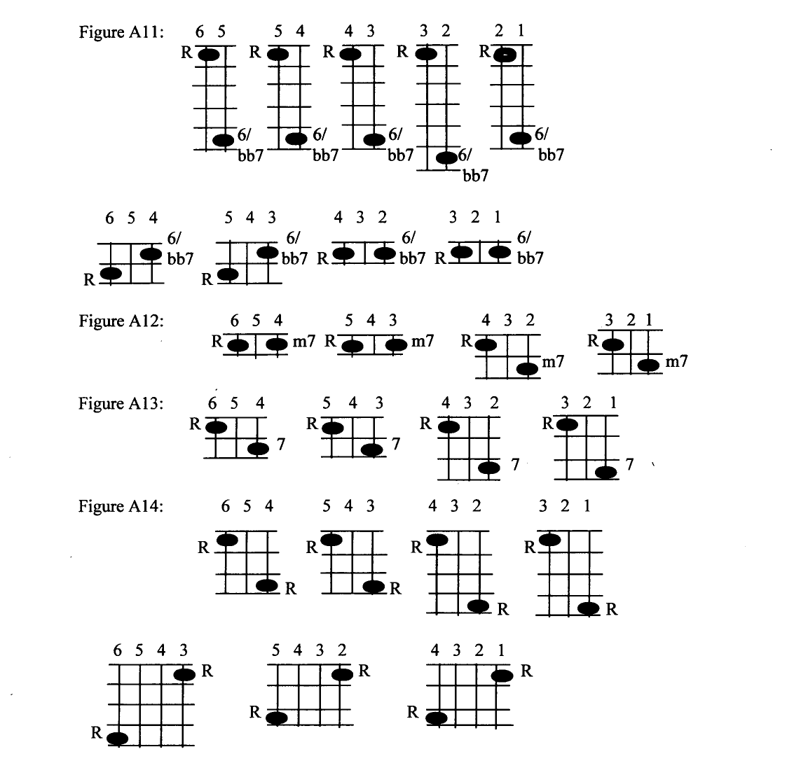

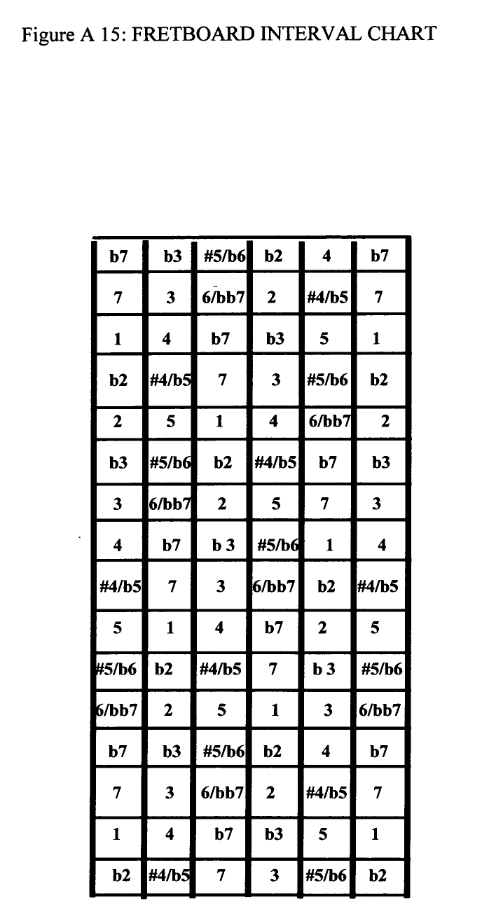

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Invention

This invention pertains to music theory, ear training and interval study.

2. Description of the Related Art

General music theory is traditionally taught one scale at a time, in one musical key at a time, with the use of standard notation of notes, timing, key signatures, terms, and definitions building from melody, to harmonic structure, to chords, to composition in series. The scale system can be confusing, in that notes are skipped, thus not included in the scale one is learning. The dedication required to thoroughly study music theory to the point of understanding all of our musical notes and how they associate with one another is rarely found. While dedicated students of music gain mastery of our musical notes, it is achieved with considerable effort and discipline. Many musicians, including professional performing artists who are proficient instrumentalists, do not recognize the relative structure that can be applied to all of our musical notes. Other students of music theory find the subject matter difficult to grasp and understand. Rarely can music theory be taught to a non musician. It is generally fed at a slow pace throughout the duration of studying to play a given musical instrument. Many fail to recognize universal patterns which make up the harmonic structure of all melodies, harmonies, chords, and musical compositions.

### BRIEF SUMMARY OF THE INVENTION

This invention provides an alternative system of learning by the use of patterns which apply universally to 12 different note combinations to encompass all the notes of our musical alphabet and therefore any musical possibility when used with instruments with musical notes in ascending or descending order, (guitar/piano/bass/banjo/mandolin). By using all 12 notes from our musical alphabet, beginner students through professional musicians are easily enabled to master every musical possibility. This method offers an in depth look at each individual note and shows how it associates with other notes, giving a full understanding of the tonal structure of melodies, harmonies, and chords, without any written or predetermined notes or key signatures. Pitch recognition and note relativity is improved, and music theory simplified.

### BRIEF DESCRIPTION OF DRAWING

The illustrations show how each universal interval pattern applies to a fretted instrument. In these examples, the patterns are applied to single strings, and double strings. The single strings are universal to any fretted instrument. The double strings shown are universal to any standard tuned guitar.

FIG. A1 depicts a standard fret chart showing the distance between a root note and a flat second interval on any string and any fret of any fretted instrument.

FIG. A2 depicts a flat second interval applied to separate strings on any six string guitar using standard tuning.

FIG. A3 depicts a fret chart showing the distance between a root note and a second interval on any fretted instrument.

FIG. A4 depicts a second interval applied to separate strings on any six string guitar using standard tuning.

FIG. A5 depicts a standard fret chart showing the distance between a root note and a minor third interval applied on any fretted instrument, then a minor third interval applied to separate strings on any six string guitar using standard tuning.

FIG. A6 depicts a standard fret chart showing the distance between a root note and a major third interval applied on any fretted instrument, then a major third interval applied to separate strings on any six string guitar using standard tuning.

FIG. A7 depicts a standard fret chart showing the distance between a root note and a perfect fourth interval applied on any fretted instrument, then a perfect fourth interval applied to separate strings on any six string guitar using standard tuning.

FIG. A8 depicts an augmented fourth/diminished fifth interval applied to separate strings on any six string guitar using standard tuning.

FIG. A9 depicts a fifth interval applied to separate strings on any six string guitar using standard tuning.

FIG. A10 depicts an augmented fifth/diminished sixth interval applied to separate strings on any six string guitar using standard tuning.

FIG. A11 depicts a sixth, or double flat seventh interval applied to separate strings on any six string guitar using standard tuning.

FIG. A12 depicts a minor seventh interval applied to separate strings on any six string guitar using standard tuning.

FIG. A13 depicts a major seventh interval applied to separate strings on any six string guitar using standard tuning.

FIG. A14 depicts an octave interval applied to separate strings on any six string guitar using standard tuning.

FIG. A15 depicts an interval chart which does not predetermine any specific musical notes or string/fretboard positioning, but shows all intervals and associated interval locations when applied to any six string guitar using standard tuning.

### DETAILED DESCRIPTION OF THE INVENTION

The “12 Note Musical Ear Training and Interval Study Method and System” is an invention of an entirely new form of music theory which can be explained to a complete novice in one day rather than years of study. First showing every note combination possibility, then learning the notes or key signatures. This system of study can be demonstrated via verbal explanation, text, computer software program, or any other media device. Charts can easily be derived from the universal patterns or distances, (as shown in the inventors upcoming book, “The Twelve Notes Of Music”).

The method can be applied to instruments with musical notes in ascending or descending order, such as a piano, a guitar, or any fretted instrument. The method allows the student to blindly pick the note on his or her instrument and quickly build from said note to encompass every musical possibility.

The invented method as follows:

The First, 1, I, the Root, the Tonic

The first, or root note, is unquestionably, unarguably the most important note of music. It is the note on which we base all other notes. The root is the base upon which all scales, melodies, harmonies, and chords are built. It's the note which names what key we are in. It is the most resolving note in a group of notes. The lack of it makes the listener want to hear it even more. To find it on your instrument, simply play a note. If your instrument is a guitar, bass, or any other fretted instrument, choose a string, choose a fret, and pick it. If you are a pianist, choose a key, white or black. That one note by itself with no other notes played before, with, or after it to influence its sound, is your root note. The note you are playing may be a Gb, or an E, or a C note.

It does not matter. Remember where it is and use it as your foundation for the following:

The Flat Second, the Minor Second, Semi Tone, b2, bii, ii

The flat second interval is a half step higher in pitch from the root. A half step is one fret up or down on a guitar/bass/fretted instrument, and one key up or down on a piano. A b2 interval is the shortest of intervals. The sound quality of just these two notes played in sequence has a minor feel or sound. The two notes played together as a harmony has a strong dissonance. Dissonance can be defined as undesirable or unresolved. (To resolve the strong dissonance of a b2nd harmony, for example, follow it with a single root note.)

The Second, 2, II

A second interval is a whole step higher in pitch than the root note. A whole step is equal to two frets up or down on a guitar or fretted instrument, or 2 keys on a piano. Played as a melody a second is the most commonly found interval in music. The sound quality of these two notes played in sequence has a neutral quality. It can lead to a major or minor quality depending on what other notes, if any, are added to its interval. The sound quality of a second harmony is defined as soft dissonance.

The Minor Third, m3, IIIm, b3, iii

A minor third interval is one and a half steps in distance. 3 frets on a guitar or fretted instrument, or 3 keys on a piano. The minor third melody is used commonly in blues, rock, pop, and soul music. A minor third melody and harmony both give a sad or mellow emotion to music. A minor third is one of the most commonly used harmonies in music.

The Major Third, 3, III

A major third interval is two steps in distance, 4 frets on a guitar/fretted instrument, 4 keys on a piano. Like the minor third, the major third is used widely in blues, rock, pop, and also country music. Also, like the minor third, the major third has an emotional sound quality. The emotion portrayed by a major third harmony or melody is bright or happy. As a harmony it is one of the most popular.

The Perfect Forth, Fourth 4, P4, IV

The perfect fourth is two and a half steps, 5 frets, or 5 keys distance. The 4th is a neutral tone. It does note have a major or minor quality/emotion to its sound. Because of this a 4th harmony or melody can be used in almost any musical situation.

When played as a chord, the IV chord is the second most popular chord used in music. The most popular chord in music would obviously be the I chord.

—Numeric Symbols—

In written music or spoken musical terms, the words perfect fourth, fourth, P4, and 4 would represent the individual note in a given key. If specified, it would also represent the harmony of a given key. For example P4 harmony, or fourth harmony.

The written roman numeral, IV, would represent that interval as a chord. It would be spoken as the four chord.

The Augmented Fourth, Sharp Fourth, 4, #4, IV+

An augmented fourth is an enharmonic interval. Enharmonic means a note with more than one name.

The other name for an augmented fourth interval is a diminished fifth.

The Diminished Fifth, Flat Five, dim5, b5, V°

The augmented fourth/diminished fifth is three steps, six frets, six keys distance. Its melody and harmony quality is suspenseful, or restless. It leaves the listener expecting a resolution. Therefore it is dissonant, but mildly so.

The Perfect Fifth, Fifth, 5, P5, V

A perfect fifth is three and a half steps, 7 frets, 7 keys distance. The tonal quality of a fifth melody or harmony is neutral. It does not have a major or minor emotion so it can be used in either situation. A fifth has an aggressive character to its sound that is resolving to the listener. It is the opposite of dissonant, which is consonant. Previous examples of consonant intervals are the 1st, b3rd, 3rd, and the 4^{th}.

The Augmented Fifth, Sharp Five, Aug 5, #5, V+

Enharmonic

The Minor Sixth, Flat Six, b6, m6, VIm, bVI, vi

An augmented fifth/minor sixth is four steps, 8 frets, or 8 keys distance. Its melody and harmony quality is suspenseful and unresolved. A #5/b6 is for the most part dissonant, but there are times when its use with other intervals will give it a mild consonance.

The Major Sixth, 6, VI

Enharmonic

°
   Diminished Seventh, dim 7, bb7 (Double Flat Seven), vii

The major sixth/diminished seventh interval is four and a half steps, 9 frets, or 9 keys distance. The sound quality is subtle, giving it a mild consonance. This melody or harmony will allow the listener to accept any other major interval.

Minor Seventh, Flat Seven, m7, b7, VIIm, vii

The minor seventh interval is five steps, 10 frets, or 10 keys distance. This interval has a soft dissonance. However, it does not present the listener with an immediate need for resolution.

This gives us the option to build upon its melody or harmony, or to resolve it with a consonant note.

The Major Seventh, 7, VII

The major seventh is five and a half steps, 11 frets, or 11 keys distance. A major seventh is often referred to as the leading tone. It is the furthest interval from the root note, and is the closest to the next octave. Its strong dissonant melody and harmony lead the listener to expect a resolution.

Any dissonant interval can be resolved by any consonant tone. The strongest consonance being that of the root.

The Octave 8va, 8/1, The First, 1, I, The Root Note, The Tonic

The octave is the same note and has the same name as the root note. The difference between the two notes is the frequency is higher or lower. The octave is six steps, 12 frets, or 12 keys in distance. An octave note is double or half the frequency of a given note. Here, at the octave, is where we apply our interval knowledge over again. This allows us to expand our musical possibilities and capabilities even further. This is how we are able to play a combination of the same 12 notes in different positions on a 120 key piano, or on a 24 fret 6 string guitar.

More About Root Notes:

As stated in Chapter 1 the root note is the most important note when building intervals. It is our foundation. In creating music it is equally important to remember the root note or 1st does not necessarily have to be played before any other note. Many songs begin on the 4th or 5th. Many creative artists avoid playing the root to make the listener anticipate it in a song. Sometimes the lack of the root will make it even more bold when a song finally does resolve to its use.

Resolution

There is no need for this method to be any longer than it is. Again, there are only 12 notes. These 12 intervals have existed as long as music itself. Once the method has been applied from root to octave, it can be extended from the octave to the next octave. After one key has been explored, another root note can be chosen to apply the method to it. This method universally applies to all 12 notes of our musical alphabet. Interval Patterns Used for Common Scales and Chords

Scales:

MAJOR=1, 2, 3, 4, 5, 6, 7, 8/1
MINOR=1, 2, b3, 4, 5, b6, b7, 8/1
MAJOR PENTATONIC=1, 2, 3, 5, 6, 8/1
MINOR PENTATONIC=1, b3, 4, 5, b7, 8/1
   Chords:
MAJOR=1, 3, 5
MINOR=1, b3, 5
DIMINISHED=1, b3, b5
AUGMENTED=1, 3, #5
SUSPENDED FOUR=1, 4, 5
MAJOR SECOND=1, 2, 3, 5
MINOR SECOND=1, 2, b3, 5
MAJOR SIXTH=1, 3, 5, 6
MINOR SIXTH=1, b3, 5, 6
MAJOR SEVENTH=1, 3, 5, 7
MINOR SEVENTH=1, b3, 5, b7
DOMINANT SEVENTH CHORDS=1, 3, 5, b7
MAJOR NINTH=1, 3, 5, 7, 9/2
MINOR NINTH=1, b3, 5, b7, 9
NINTH=1, 3, 5, b7, 9
MAJOR ELEVENTH=1, 3, 5, 7, 9, 11/4
MINOR ELEVENTH=1, b3, 5, b7, 9, 11
ELEVENTH=1, 3, 5, b7, 9, 11
MAJOR THIRTEENTH=1, 3, 5, 7, 9, 11, 13/6
MINOR THIRTEENTH=1, b3, 5, b7, 9, 11, 13
THIRTEENTH=1, 3, 5, b7, 9, 11, 13

The Musical Alphabet

The musical alphabet consists of 12 notes.

| A | A♯/Bb | B | C | C♯/Db | D | D♯/Eb | E | F | F♯/Gb | G | G♯/Ab | A |
|---|---|---|---|---|---|---|---|---|---|---|---|---|
| 1 | 2 | 3 | 4 | 5 | 6 | 7 | 8 | 9 | 10 | 11 | 12 | 1 |

The notes A, B, C, D, E, F, & G are called basic or natural notes.
The notes A♯/Bb, C♯/Db, D♯/Eb, F♯/Gb, & G♯/Ab are called accidentals.

### The Musical Alphabet and the Guitar, Bass (any fretted instrument), and Piano

GUITAR: Each of the six strings of the guitar have been assigned a specific note. The 6th string, which is the top and heaviest string is an E note. It is called the low E string. When this string is played OPEN (no frets), it will produce an E pitch. Each fret after that will bring you to the next note in the musical alphabet.

### EXAMPLE

If you play the 1st fret of the 6th string it will produce a F note, the 2nd fret will produce a F#/Gb note, 3rd fret will produce a G note, next a G#/Ab note, then A, the 6th fret will be an A#/Bb note, 7th fret B, 8th C, ETC. . . Once you reach the 12th fret the musical alphabet will repeat itself starting with the E note. The 5th string open is an A note. The 4th string is a D note. 3rd string is a G note. 2nd is the B string. The 1st string is the high E string.

BASS: Standard tuning on a bass guitar is E for the 4th or heaviest string open, the third string open is an A note, 2nd string open is a D note, and the first string open is a G note.

PIANO: On a Piano, the white keys are natural notes, and the black keys are the sharps and flats. The black keys are in groups of two and three. The white key between the group of 2 black keys is always a D note. When you ascend in pitch from left to right each key will produce the next note in the musical alphabet.

What I claim as my invention is:

1. A method for representing the structure of all western music comprised of using every note, and establishing the recognizable 12 universal patterns present in all music, scales, melodies, harmonies, chords, and composition without the use of standard notation, exhausting hours of study, or the use of large and complicated text books.

2. A method according to claim 1, wherein music theory is simplified.

3. A method according to claim 1, wherein presents a new form of music theory which is easily understood regardless of skill or previous musical knowledge.

4. A method according to claim 1, wherein musical pitch recognition is improved.

5. A method according to claim 1, wherein the 12 universal musical patterns encompass all scales, harmonies, chords and composition.

6. A method according to claim 1, wherein knowledge of all western music can be gained without the use of traditionally notated sheet music.

7. A method according to claim 3, wherein allows any user to blindly choose a single musical note at random and quickly apply and learn how it associates with all other notes to encompass all styles and possibilities of western music.

8. A method according to claim 7, wherein can be applied to all 12 notes of the western musical alphabet, therefor encompassing all notes, scale, harmony, chord, and composition possibilities in western music.
